(19) United States
(12) Patent Application Publication
(10) Pub. No.: US 2011/0206069 A1
(43) Pub. Date: Aug. 25, 2011

(54) Blue Dysprosium Laser

(75) Inventors: Steven R. Bowman, Edgewater, MD (US); Nicholas J. Condon, Silver Spring, MD (US); Shawn P. O'Connor, Dunkirk, VA (US)

(73) Assignee: United States Government in the name of the Secretary of the Navy

(21) Appl. No.: 12/964,599

(22) Filed: Dec. 9, 2010

Related U.S. Application Data
(60) Provisional application No. 61/267,863, filed on Dec. 9, 2009.

(51) Int. Cl. H01S 3/11; H01S 3/093

(52) U.S. Cl. 372/10; 372/72

(57) ABSTRACT

A quasi-three level laser system having crystalline YAG or YLF doped with trivalent Dysprosium can be pumped with a laser diode in the UV, and produce a pulsed laser blue emission from the 4 F _{9/2} energy level at 490 nm, a red emission at 660 nm, or a yellow emission at 570 nm. The system can operate at room temperature or be cooled. The system can include Q-switching. A suitable laser diode is GaN.

### CROSS REFERENCE TO RELATED APPLICATIONS

This Application is a nonprovisional of provisional (35 USC 119(e)) application 61/267,863 filed on Dec. 9, 2009, the entire disclosure of which is incorporated herein by reference.

### BACKGROUND

1. Technical Field

The present invention relates to crystal laser material, and more particularly, to lasers operating in blue-green wavelengths.

2. Related Technology

Bulk solid-state lasers have found wide utility in applications requiring compact, frequency-agile sources.

However, many of these lasers operate at wavelengths that are quickly absorbed by water. FIG. 1 illustrates the optical transmission characteristics of different types of seawater, including type I, 11, type IA, 12, type IB, 13, type II, 14, and type III, 15. In general, the longer red, yellow, and orange wavelengths are attenuated more rapidly than the shorter violet, blue, and green wavelengths. The blue-green band 10 with wavelengths between 400 and 490 nm are of interest for underwater communication, rangefinding, and other applications.

For these reasons, lasers that operate at wavelengths that are not as quickly absorbed in water have been sought for undersea communications and other military and commercial applications. Some previously developed solid state blue lasers are based on nonlinear frequency conversion of near infrared lasers such as Neodynium yttrium aluminum garnet (Nd:YAG or Nd:Y₃Al₅O₁₂) or Titanium Sapphire (Ti:Al₂O₃).

FIG. 2 illustrates a typical diode-pumped blue laser system 20 with a Q-switched Nd:YAG high brightness laser resonator 21 pumped by an 800 nm GaAlAs laser diode 22. The Nd:YAG output at 1064 nm is frequency doubled with a doubling crystal 23 to a wavelength of 532 nm, and the 532 nm beam pumps a tunable Q-switched Ti:Sapphire laser resonator 24. The 910 nm output of the Ti:Sapphire laser resonator is frequency doubled with a doubling crystal 25 to a wavelength of 455 nm. Thus, although the near-infrared GaAlAs lasers can be reliable and compact, converting their laser outputs to blue can increase complexity and degrade their efficiency.

Another approach to generating blue-solid state lasers is based on multi-photon pumped gain medium. These lasers absorb two or more near-infrared photons to generate a single blue photon. Usually based on excited state absorption or non-radiative upconversion, these lasers often rely on cryogenic operation or very intense pump sources to enhance the multiple excitation process. An example of multi-photon pumping in Thulium ZBLAN is described in C. P. Wyss et al., “Excitation of the thulium 1G4 level in various crystal hosts”, Journal of Luminiscence, Vol. 82, pp. 137-144, 1999. These approaches have limited efficiency and can also be somewhat complex. J. Limpert et al., “Laser oscillation in yellow and blue spectral range in Dy³⁺ ZBLAN”, Electronics Letters, Vol. 36. No. 16, pp. 1386-87, (Aug. 2000) discloses a laser with ZBLAN glass fiber doped with 1000 ppm by weight Dy3+.

S. Nakamura et al., “First laser diodes fabricated from III-V nitride based materials”, Mat. Sci. & Engineering B, Vol. 43, (1997), pp. 258-264, describes current-injected InGaN multiple quantum well structure laser diodes with strong stimulated emissions at 406 nm.

In Applied Physics Letters, Vol. 94, pp. 071105 (2009), K. Okamoto et al., discloses nonpolar m-plane InGaN multiple quantum well laser diodes with lasing wavelengths of about 489.4 to 492.8 nm and about 490.5 to 499.8 nm.

In “Crystal Field in Dysprosium Garnets”, Phys. Rev., Vol. 184, No. 2, pp. 285-293, (1969), Grunberg et al. measured the infrared spectrum of dysprosium garnet, including yttrium aluminum garnet. From these measurements, Grunberg predicted the Stark energy levels of the lower lying manifolds, but did not examine the visible transitions.

U.S. Pat. No. 7,616,668 to Anh et al. discloses an optical fiber laser having host glass formed of fluoride-based glass, sulfide-based glass, or selenium-based glass doped with Dysprosium. A Dysprosium-doped fluoride fiber laser with stimulated emission in the infrared is described in S. J. Jackson, “Continuous wave 2.9 um dysprosium-doped fluoride fiber laser”, Applied Physics Letters, Vol. 83, No. 7, pp. 1316-1318, August 2003.

A Dysprosium-doped crystal laser material containing lead, gallium, and sulfur is described in U.S. Pat. No. 7,558,304 to Valer'evich Badikov et al.

### BRIEF SUMMARY

A laser system includes a gain medium including a dysprosium-doped crystalline host material, and reflectors arranged on both ends of the gain medium to form a resonant cavity. The gain medium is operable to receive pump light at a wavelength that excites electrons of the Dysprosium from a ground energy level to a 4f energy level, resulting in stimulated emission between the 4F_{9/2} energy level and a 6h energy level and an output of pulsed laser light having a wavelength of at least 480 nm.

The laser system can have a wavelength of 497 nm, 660 nm, or 570 nm. The gain medium can emit photons between the 4F_{9/2} energy level and the 6H_{15/2} energy level, the 4F_{9/2} energy level and the 6H_{13/2} energy level, or the 4F_{9/2} energy level and the 6H_{11/2} energy level.

The pump light can have a wavelength of between 300 and 450 nanometers. A suitable pump wavelength is 447 nm.

The host material can be Yttrium aluminum garnet or Yttrium lithium fluoride. The dysprosium dopant concentration can be at least one percent with the host material being Yttrium aluminum garnet. The dysprosium dopant concentration can be between one percent and two percent with the host material being Yttrium aluminum garnet. The dysprosium dopant concentration can be between one percent and five percent with the host material being Yttrium lithium fluoride.

A lens can focus the pump light source into the gain medium. The laser system can also include a pump light source for generating said pump light, with the pump light source being at least one laser diode or a plurality of laser diodes. The at least one laser diode can be a gallium nitride laser diode. A laser system can also include a Q switch disposed along an optical path in the resonant cavity between the gain medium and one of the reflectors. The laser system can also include a multimode fiber arranged between the pump light source and the resonant cavity to transmit the pump light to the resonant cavity.

The laser system can operate at room temperature without a cooling system, or can include a cooling system.

A method for generating laser pulses uses a gain medium including a dysprosium-doped crystalline host material and reflectors arranged at both ends of the gain medium to form a resonant cavity. The method includes exciting said gain medium with a pump light at a wavelength that excites electrons of the Dysprosium from a ground energy level to a 4f energy level, and emitting pulsed laser light having a wavelength of at least 480 nm as the electrons transition from a 4F_{9/2} to a 6h energy level.

The pulsed laser light can have a wavelength of 497 nm, 660 nm, or 570 nm. The gain medium can emit photons between the 4F9/2 energy level and the 6H_{15/2} energy level, the 4F_{9/2} energy level and the 6H_{13/2} energy level, or the 4F_{9/2} energy level and the 6H_{11/2} energy level. The pump light can have a wavelength of between 300 and 450 nanometers. A suitable pump wavelength is 447 nm.

The host material can be Yttrium Aluminum Garnet or Yttrium lithium fluoride. The dysprosium dopant concentration can be at least one percent with the host material being Yttrium aluminum garnet. The dysprosium dopant concentration can be at least between one percent and two percent, with the host material being Yttrium aluminum garnet. The dysprosium dopant concentration can be between one percent and five percent, with the host material being Yttrium lithium fluoride.

The method can also include focusing the pump light source into the gain medium. A pump light source can be at least one laser diode, a plurality of laser diodes, and a suitable laser diode is a gallium nitride laser diode. Q-switching within the resonant cavity can produce short laser pulses.

A method for communications includes generating a series of laser pulses, encoding a communication signal on the laser pulses, and transmitting the encoded laser pulses from a source to a receiver. The laser pulses are generated with a gain medium including a dysprosium-doped crystalline host material and reflectors arranged at both ends of the gain medium to form a resonant cavity, and includes exciting said gain medium with a pump light at a wavelength that excites electrons of the Dysprosium from a ground energy level to a 4f energy level, and emitting pulsed laser light having a wavelength of at least 480 nm as the electrons transition from a 4F_{9/2} to a 6h energy level. One or both of the source and the receiver can be underwater.

A method for determining a range to a object includes generating laser pulses, transmitting the pulses toward the object, receiving reflected pulses from the object, and determining the range based on the time interval between transmitting the pulses and receiving the reflected pulses. The laser pulses are generated with a gain medium including a dysprosium-doped crystalline host material and reflectors arranged at both ends of the gain medium to form a resonant cavity, and includes exciting said gain medium with a pump light at a wavelength that excites electrons of the Dysprosium from a ground energy level to a 4f energy level, and emitting pulsed laser light having a wavelength of at least 480 nm as the electrons transition from a 4F_{9/2} to a 6h energy level. The object can be underwater.

### BRIEF DESCRIPTION OF THE DRAWINGS

FIG. 1 is a graph showing the seawater attenuation coefficient for light at wavelengths between 200 and 750 nanometers.

FIG. 2 illustrates a conventional diode-pumped blue laser that relies on frequency doubling crystals.

FIG. 3 illustrates the energy level structure of trivalent Dysprosium (Dy³⁺) with a blue-UV pump at 390 nm.

FIG. 4 illustrates the room temperature absorption spectra of Dysprosium-doped Y₃Al₅O₁₂ and Dysprosium-doped YLiF₄.

FIG. 5A and 5B show the normalized fluorescence of 1% Dysprosium-doped Y₃Al₅O₁₂ and 5% Dysprosium-doped YLiF₄.

FIG. 6A shows the room temperature fluorescence spectra of YLF and YAG crystals with a 2.8×10²⁰ ion/cm³ Dysprosium concentration when pumped with a 365 nm excitation source.

FIG. 6B shows the room temperature absorption and fluorescence spectra of a 2% Dy:YAG crystal with a length of one centimeter.

FIG. 7 shows a diode pumped laser system with a Dysprosium-doped YAG or YLF crystal within a resonant cavity in accordance with an embodiment of the invention.

FIG. 8 illustrates a laser system with a Dysprosium-doped YAG or YLF crystal and an active Q-switch within the resonant cavity and multiple laser diodes.

FIG. 9 illustrates the blue emission and absorption cross sections for the Dy:YAG crystal, with the emission spectra determined from the absorption spectra using a principle of reciprocity.

FIG. 10 illustrates the predicted performance of the model with a continuous wave (cw) pumped, repetitively Q-switched Dy:YAG laser for different repetition rates.

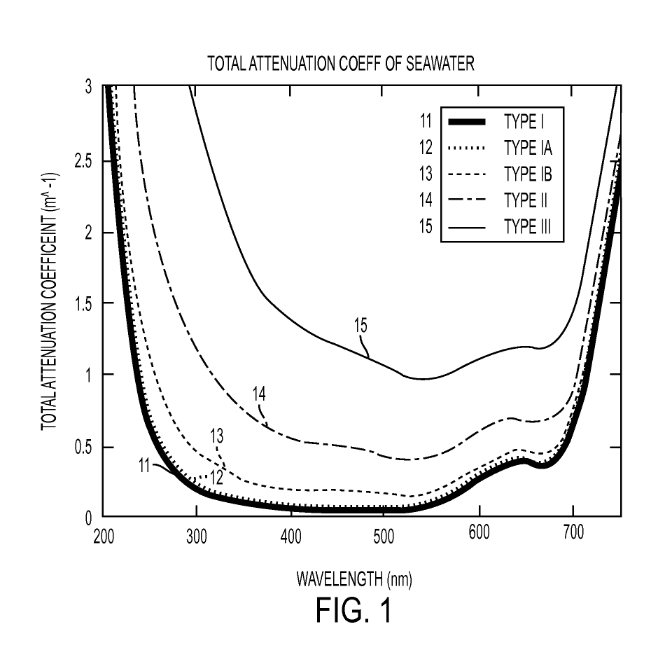

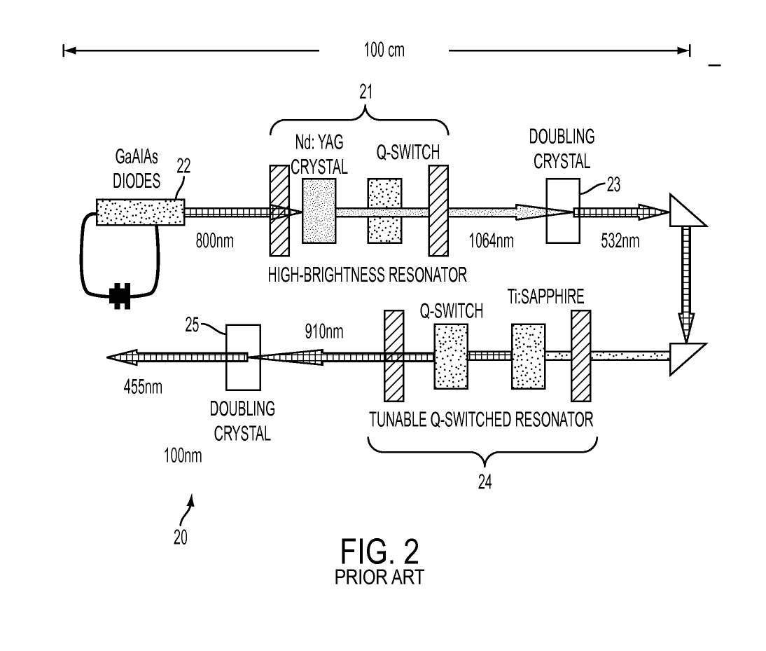

Additional details will be apparent from the following detailed description of embodiments of the invention.

### DETAILED DESCRIPTION OF EMBODIMENTS OF THE INVENTION

Embodiments of the invention are directed to a compact and practical laser source suitable for use in underwater applications operating in the 450 to 500 nm primary transmission window of water.

An embodiment of the invention is a laser system that includes a gain medium of a nonlinear crystal doped with trivalent Dysprosium (Dy³⁺).

The gain medium can be Dy³⁺ doped Yttrium aluminum garnet (YAG or Y₃Al₅O₁₂) or Yttrium lithium fluoride (YLF or LiYF₄). The Dy:YAG or Dy:YLF gain medium can be pumped by a laser diode in the blue-ultraviolet (UV) wavelengths.

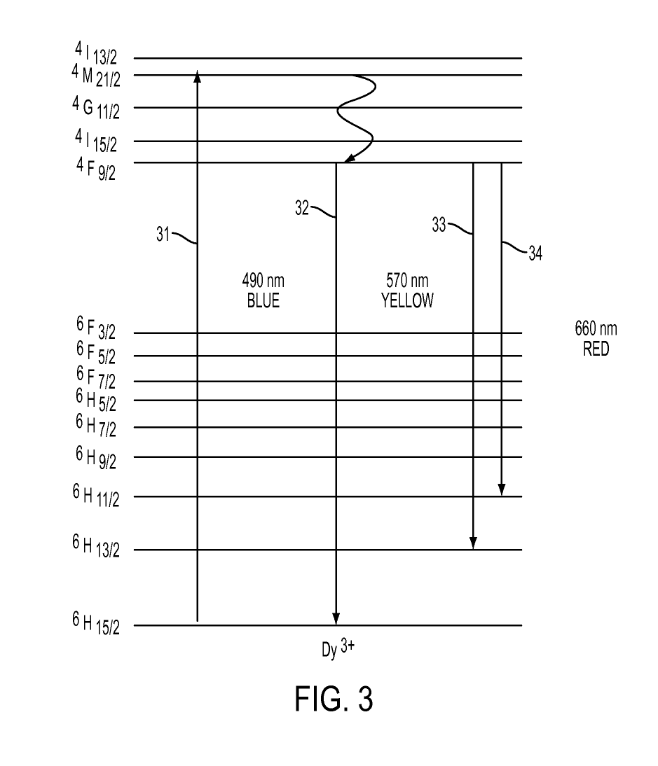

FIG. 3 shows the energy level structure of the 4f electrons in trivalent Dysprosium (Dy³⁺). FIG. 3 shows the blue-UV pump at 390 nm, an observed blue emission line at 490 nm, an observed yellow emission line at 570 nm, and an observed red emission line at 660 nm. Multiphonon quenching of the higher lying levels occurs rapidly in both oxides and fluorides. This gives rise to energy pooling in the metastable 4F_{9/2} level. Measurements show that the 4F_{9/2} level in Dy:YAG has a lifetime of 870 microseconds, which is ample time for conventional laser diode pump sources to build significant excited populations in the 4F_{9/2} level.

The absorption spectra can be studied using a Cary 550 spectrophotometer and a Nicolet 760 FTIR spectrometer, with the fluorescence spectra being acquired using a 0.25 nm resolution Ocean HR 4000 spectrometer. Steady state excitation is generated using a filtered mercury vapor lamp. Pulsed excitation of the samples is accomplished either with a GaN light emitting diode (LED) array or an Ocean PX2 flashlamp. Fluorescent decay waveforms are measured with a narrowband filtered silicon detector and recorded on a Techtronic 714 oscilloscope.

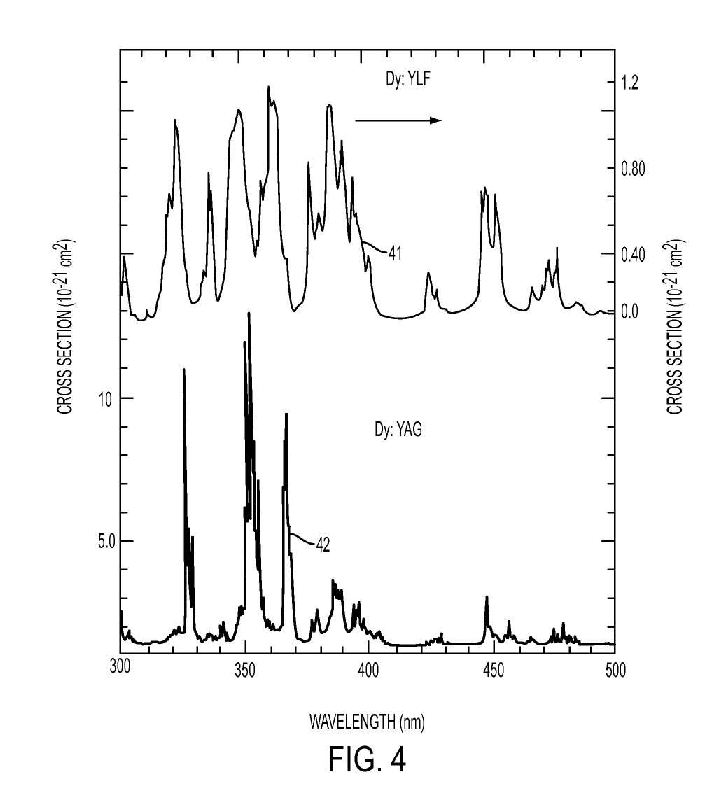

Results of these studies are shown in FIG. 4, which illustrates the room temperature absorption spectra of Dysprosium-doped Y₃Al₅O₁₂ and Dysprosium-doped YLiF₄. In both crystals, the spectra are unpolarized.

The Dy:YLF plot 41 shows that the Dy:YLF absorption cross section varies between 0 and about 1.1×10⁻²¹ cm² over the wavelength range of 300 to 500 nm. The Dy:YAG plot 43 shows that the absorption cross section varies between 0 and about 10 x 10⁻²¹ cm². Both crystals have broad absorption bands between 300 nm and 400 nm. Note that the maximum absorption cross section of the Dy:YAG is approximately an order of magnitude larger than the absorption cross section of the Dy:YLF sample for comparable doping densities.

The strength of the near-UV absorption depends on the dysprosium host material. Dy:YAG exhibits stronger absorption per ion than Dy:YLF in the 370 nm-400 nm band where the laser can be pumped. For modest doping densities of approximately 10²⁰ ions per cm³, near-UV absorption lengths will be centimeter scale in Dy:YAG.

The spectral measurements show that the Dy3+ 6H_{15/2} ground state manifold in Dy:YAG have a Stark splitting of 743 cm⁻¹. This result is significantly higher than the value reported by Azamatov, but consisted with the early near-IR work of Grunberg. As a result, the population inversion of the 497 nm transition requires less than 2% Dy³⁺ excitation at room temperature.

Dysprosium laser action on the 4F_{9/2} to 6H_{15/2} transition can proceed in a quasi-three level laser configuration. (The invention disclosure says Stark splitting occurs at 743 cm−1, the slides say 739 cm−1, and the

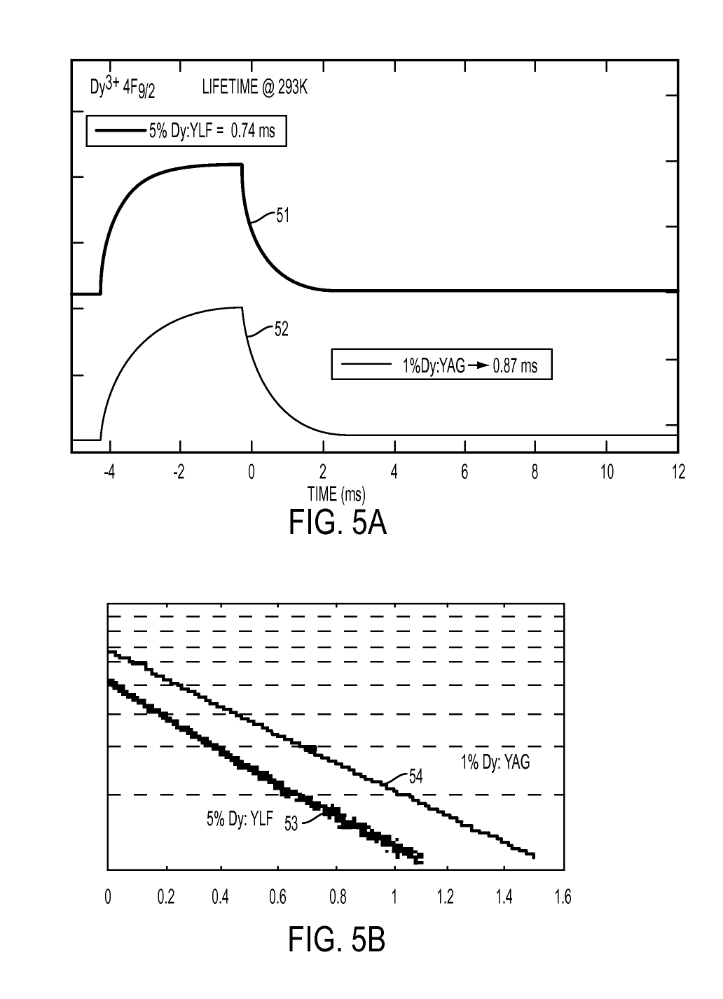

FIG. 5A illustrates the temporal behavior of the normalized fluorescence generated by both Dy:YLF and a Dy:YAG crystals when pumped by a 5 ms pulse from a 395 nm GaN LED. The normalized waveform 51 in FIG. 5A shows the build-up and decay of the 497 nm emission for a square 5 ms diode pulse for a 5% Dy:YLF crystal. The normalized waveform 52 in FIG. 5A shows the build-up and decay of the 497 nm emission for a square 5 ms diode pulse for 1% Dy:YAG crystal. The immediate rise in each of the waveforms indicates a short lifetime for the UV pumped states. FIG. 5B is a semilog graph illustrating the near exponential fit to the decay for the 5% Dy:YLF 53 and for the 1% Dy:YAG crystal 54.

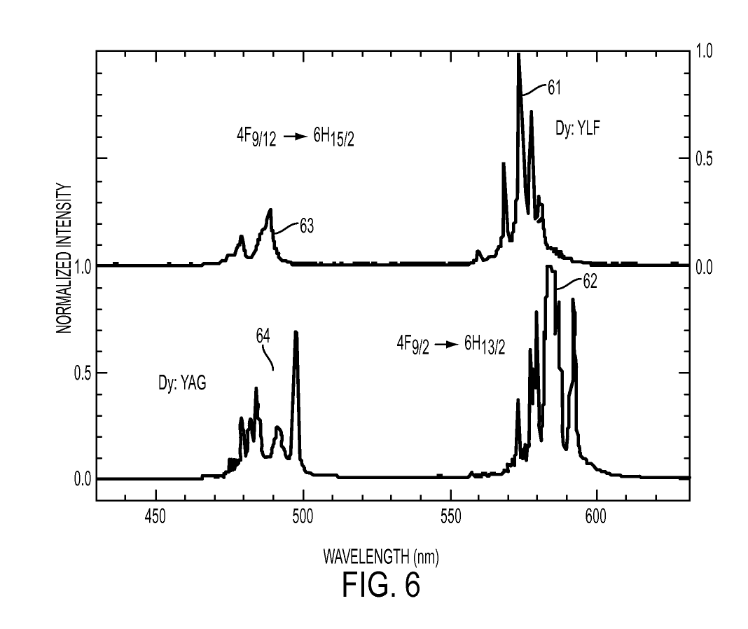

FIG. 6A shows the room temperature fluorescence spectra (visible emission spectra) of YLF and YAG crystals with a 2.8×10²⁰ ion/cm³ Dysprosium concentration when pumped with the 365 nm line of a low pressure mercury lamp as the excitation source. The principal emission yellow and blue bands of the 4F9/2 level are apparent. In both materials, the yellow emission bands 61, 62 are the strongest emission bands. In YAG, the blue emission band 64 is comparable in strength to the yellow, but in YLF, the blue emission band 63 is much weaker than the yellow emission band. The red and infrared emission bands are weaker still. The emission bands are centered at 485 nm and 585 nm in YAG, but are blue shifted about 10 nm in YLF. The spectra are unpolarized.

Note that the higher Dy³⁺ dopant concentration in the Dy:YLF crystal is intended to offset the weaker UV absorption cross section of the Dy:YLF apparent in FIG. 4.

FIG. 6B shows the room temperature fluorescence spectra of a 2% Dy:YAG crystal with a length of one centimeter. FIG. 6B also shows the absorption spectra 67 of the material over the range from 300 to 500 nanometers. In the fluorescence spectra, the yellow emission band 65 and the blue emission band 66 result from the 4F_{9/2} to 6H_{13/2} and the 4F_{9/2} to 6H_{15/2} transitions, respectively.

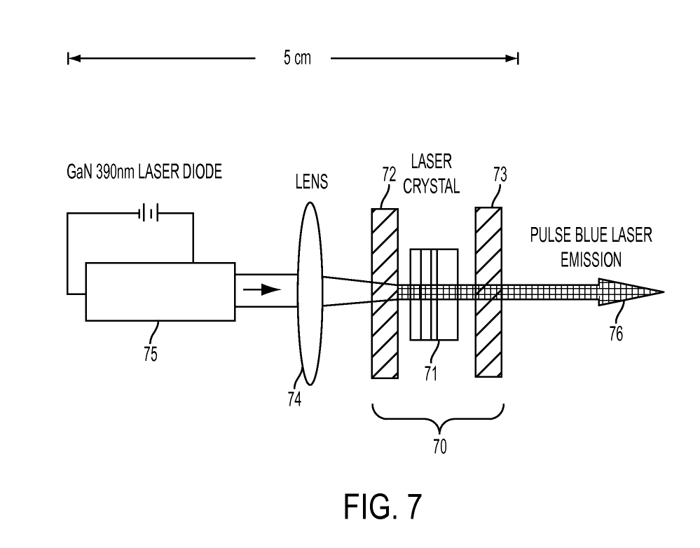

FIG. 7 illustrates an exemplary diode-pumped laser system based on a Dysprosium doped crystal. The gain medium of the laser system can be a crystal rod of Dy:YAG or Dy:YLF. In this example, the gain medium is a YAG crystal doped with 2% Dysprosium.

The near UV beam emitted by the GaN diode 75 is captured and focused by a fast lens 64 into the Dysprosium-doped crystal gain medium 71 within the resonant cavity 70. The near-UV beam will be absorbed into the Dysprosium-doped crystal. Gain generated in the crystal results in stimulated emission within the cavity defined by the reflectors 72 and 73. Blue dysprosium laser emission 66 couples out through the partially reflective mirror 73.

The reflectors 72 and 73 arranged at either end of the Dy:YAG crystal 71 are reflective in the wavelengths at which the gain medium lases. The reflector 73 can be partially reflective in these wavelengths to allow the stimulated emission to exit the resonator cavity. The output of the laser cavity 70 will be laser pulses at the blue lasing wavelength of 490 nm. Alternatively, both reflectors 72 and 73 can be highly reflective and a beamsplitter (not shown) can be arranged in the optical path between the reflectors.

The reflectors can be separate elements spaced apart from the ends of the crystal, or can be reflective coatings on the ends of the crystal.

For systems in which the reflectors are not coatings on the faces of the crystal gain medium, antireflective coatings can be provided on the crystal to minimize back-reflections.

The cavity length, mirror curvature, and crystal rod position can be adjusted to match the pump spot to the TEM₀₀ mode.

The gain medium is pumped in the wavelength range in which the doped crystal is absorptive. The pump energy can provided by a laser diode 75 operating in the near ultraviolet wavelengths, and preferably between about 320 nm and 450 nm in wavelength. In this example, the GaN laser diode operates at 387 nm, which corresponds to a peak in the crystal's absorption cross section. This pump wavelength can provide good single pass pump coupling.

There are some important differences between optical pumping with GaN laser diodes and pumping with near-IR sources. The shorter wavelengths of the GaN laser diodes lead to higher intrinsic brightness. The larger bandgaps result in higher operating voltages, e.g., 5-6 Volts, as well as weaker temperature tuning rates, e.g., 50-60 pm/deg C. The GaN laser diodes also have impressive wavelength agility over the range of 320-500 nm.

Although a single laser diode is shown in the example of FIG. 7, multiple GaN laser diodes can be combined to increase the output power. Currently available GaN laser diodes can produce up to about one Watt, with efficiencies of about 20% or less, so combining these diodes for optical pumping can provide a stronger pump beam. For example, four diodes can be combined into a 2.5 W pump source to provide a 400 micron spot focused into the crystal gain medium.

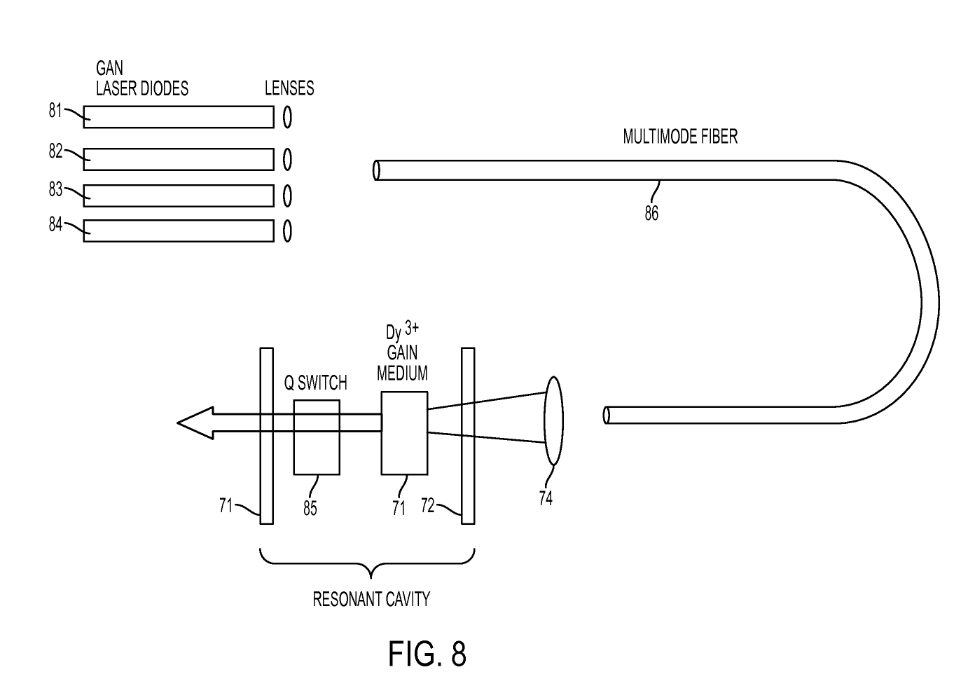

One source for a GaN laser diode operating in the 395-450 nm wavelength range is Nichia Chemical Industries, headquartered in Tokushima, Japan. Other manufacturers of GaN laser diodes include Sony, Sharp, and Sanyo. Nichia manufactures a suitable GaN laser diode that produces 0.6 Watts at 403 nm, and a laser diode that produces about one Watt at 447 nm, which correspond to a strong absorption band Dy:YAG and Dy:YLF. A Q-switch can be arranged in the resonant cavity between one of the reflectors and the crystal. The Q-switch can be, for example, an acousto-optic modulator or an electro-optic modulator. Because of the relatively long energy storage of Dy:YAG and Dy:YLF, Q-switching can produce high power short pulses with lengths in the nanosecond or shorter range. FIG. 8 illustrates a laser system with an active Q-switch 85 and multiple pump laser diodes 81, 82, 83, and 84.

The absorption coefficient of the crystal is 0.99 cm⁻¹. The laser wavelength is 497 nm. The mode volume is 0.04×2 cm. The cavity length, minor curvature, and rod position are adjusted to match the pump spot to the TEM₀₀ mode. The resonator length is 90 cm. The mirror curvature is 70 cm. The Dy3+ density is 2.76×10²⁰ cm³. The storage lifetime is 870 microseconds. The Dy³⁺ 6H_{15/2} levels are 0 cm⁻¹, 65 cm⁻¹, 100 cm⁻¹, 177 cm⁻¹, 232 cm⁻¹, 456 cm⁻¹, 662 cm⁻¹, and 739 cm⁻¹. The Dy³⁺ 4H_{9/2} levels are 20868 cm⁻¹, 20899 cm⁻¹, 20960 cm⁻¹, and 21128 cm⁻¹.

As shown in FIG. 8, the pump laser energy can also be transmitted over a distance through a multimode optical fiber 86 to a remotely located resonant cavity 87, which includes the Dy3+ doped crystal gain medium 71 and the Q-switch 85. As in the system of FIG. 7, a lens 74 focuses the pump energy into the gain medium 71.

The spectral data described above is incorporated into a model for a diode pumped blue laser. Simulation of a model of this system uses several assumptions. First, a Dy:YAG crystal is selected based on its stronger blue emission and higher Stark splitting. The system is operated at room temperature of 293 K. The cavity losses are assumed to be dominated by a transmission output coupler (e.g., the partially reflective minor 72 of FIG. 7) with a loss of approximately 8%. The pump wavelength is 387 nm, to ensure good single pass pump coupling.

Multiple laser diodes are focused with a 400 micron diameter spot size into a single end-pumped 2% Dy:YAG rod that is 2 cm in length. The model assumes cw pumping with high repetition rate Q-switching.

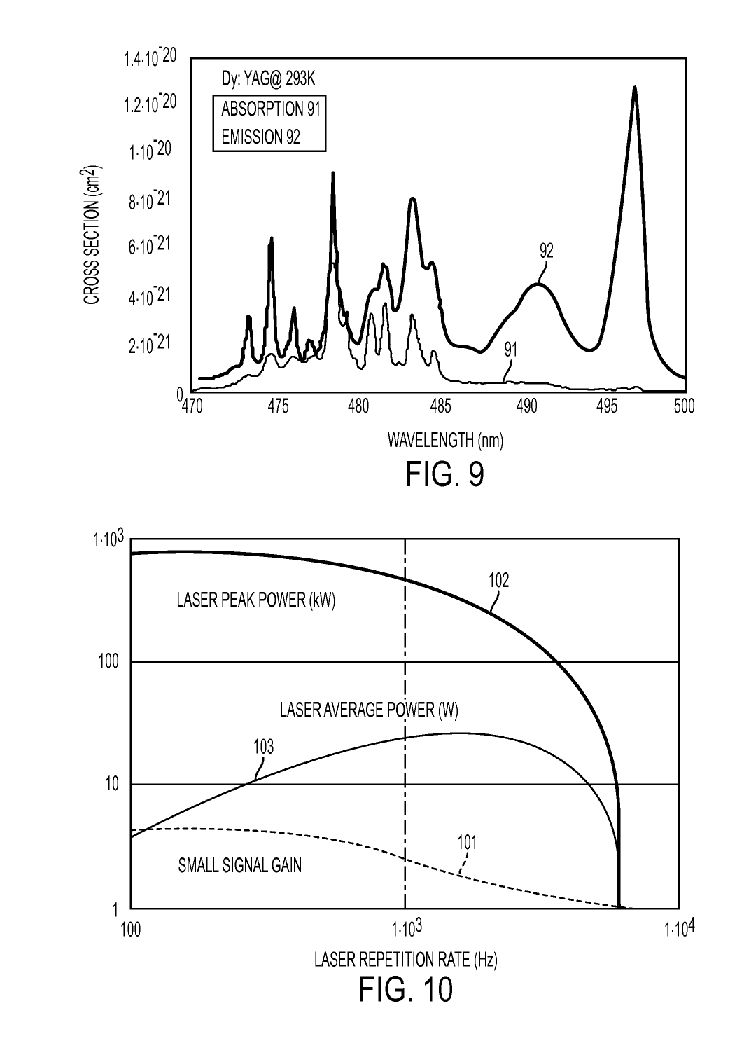

FIG. 9 illustrates the blue emission and absorption cross sections for the Dy:YAG crystal, with the emission spectra determined from the absorption spectra using a principle of reciprocity.

FIG. 10 illustrates the predicted performance of this laser model. The small signal gain 101, laser peak power 102, and laser average power 103 are plotted against the laser repetition rate.

For a pump laser with 100 W of pump power, and with pump coupling assumed to be 86%, the optimal average power is predicted to be 25 W with a 2 kHz repetition rate. The signal gain is 0.38 cm⁻¹. Optical efficiency is projected at 25% with a significant threshold power of 17 W. Thus, assuming a 50 ns Q-switched laser pulse, the laser can support a megawatt peak power application.

The Dy³⁺:YAG and Dy³⁺:YLF laser systems described herein can operate at room temperature, however, cooling the gain medium can improve its performance. For example, thermal occupation of the terminal level of the 497 nm laser in Dy:YAG is estimated to be 1.9% at room temperature. This leads to a requirement for high power pumping. However, if the laser material is cooled to 200 K, the terminal level occupation drops to 0.3%, allowing construction of efficient systems with 10 W of pump power. Alternatively, the Dy+ host can be a different material having higher field splitting.

Other host materials than YAG and YLF crystals can be used to host the active Dysprosium ions. The concentration and host will determine the frequency of the laser's emission peak.

Other geometries for the laser include ribs, disks, slabs, and fibers. This system can also be operable with single or tunable frequencies, steady-state or pulsed operation with stable or unstable resonators.

The lasers described herein can also be configured as oscillators or amplifiers.

The laser system can be used for communication. In operation, the laser generates a series of laser pulses with a wavelength of 490 nm, a signal is encoded on the laser pulses, and the encoded laser pulses are transmitted from the source to a receiver. One or both of the source or receiver can also be underwater in fresh water or seawater.

The laser system can also be configured for rangefinding. The laser pulses are transmitted toward an object, and reflected pulses from the object are received at a receiver. The distance to the object can be determined based on the time interval between the time a pulse is transmitted and the time the reflected pulse is received.

The invention has been described with reference to certain preferred embodiments. It will be understood, however, that the invention is not limited to the preferred embodiments discussed above, and that modification and variations are possible within the scope of the appended claims.

What is claimed as new and desired to be protected by Letters Patent of the United States is:

1. A laser system comprising:
a gain medium including a dysprosium-doped crystalline host material; and
reflectors arranged on both ends of the gain medium to form a resonant cavity;
said gain medium operable to receive pump light at a wavelength that excites electrons of the Dysprosium from a ground energy level to a 4f energy level, resulting in stimulated emission between the 4F9/2 energy level and a 6h energy level and an output of pulsed laser light having a wavelength of at least 480 nm.

2. The laser system according to claim 1, wherein the pulsed laser light has a wavelength of 497 nm.

3. The laser system according to claim 1, wherein the pulsed laser light has a wavelength of 660 nm.

4. The laser system according to claim 1, wherein the pulsed laser light has a wavelength of 570 nm.

5. The laser system according to claim 1, wherein said gain medium emits photons between the 4F_{9/2} energy level and the 6H_{15/2} energy level.

6. The laser system according to claim 1, wherein said gain medium emits photons between the 4F_{9/2} energy level and the 6H_{13/2} energy level.

7. The laser system according to claim 1, wherein said gain medium emits photons between the 4F_{9/2} energy level and the 6H_{11/2} energy level.

8. The laser system according to claim 1, wherein said pump light has a wavelength of between 300 and 450 nanometers.

9. The laser system according to claim 1, wherein said pump light has a wavelength of 447 nm.

10. The laser system according to claim 1, wherein the host material comprises Yttrium aluminum garnet or Yttrium lithium fluoride.

11. The laser system according to claim 1, wherein the dysprosium dopant concentration is at least one percent and the host material comprises Yttrium aluminum garnet.

12. The laser system according to claim 1, wherein the dysprosium dopant concentration is between one percent and two percent, and the host material comprises Yttrium aluminum garnet.

13. The laser system according to claim 1, wherein the dysprosium dopant concentration is between one percent and five percent, and the host material comprises Yttrium lithium fluoride.

14. The laser system according to claim 1, further comprising:
a lens arranged to focus the pump light source into the gain medium.

15. The laser system according to claim 1, further comprising:
a pump light source for generating said pump light.

16. The laser system according to claim 1, wherein said pump light source is at least one laser diode.

17. The laser system according to claim 1, wherein the pump light source is a plurality of laser diodes.

18. The laser system according to claim 16, wherein the at least one laser diode is a gallium nitride laser diode.

19. The laser system according to claim 1, further comprising:
a Q-switch disposed along an optical path in the resonant cavity between the gain medium and one of the reflectors.

20. The laser system according to claim 1, further comprising:
a multimode fiber arranged between the pump light source and the resonant cavity to transmit the pump light to the resonant cavity.

21. The laser system according to claim 1, wherein the laser operates at room temperature without a cooling system.

22. The laser system according to claim 1, further comprising:
a cooling system for cooling the gain medium.

23. A method for generating laser pulses with a gain medium including a dysprosium-doped crystalline host material and reflectors arranged at both ends of the gain medium to form a resonant cavity, the method comprising:
exciting said gain medium with a pump light at a wavelength that excites electrons of the Dysprosium from a ground energy level to a 4f energy level; and
emitting pulsed laser light having a wavelength of at least 480 nm as the electrons transition from a 4F9/2 to a 6h energy level.

24. The method according to claim 23, wherein the pulsed laser light has a wavelength of 497 nm.

25. The method according to claim 23, wherein the pulsed laser light has a wavelength of 660 nm.

26. The method according to claim 23, wherein the pulsed laser light has a wavelength of 570 nm.

27. The method according to claim 23, wherein said gain medium emits photons between the 4F_{9/2} energy level and the 6H_{15/2} energy level.

28. The method according to claim 23, wherein said gain medium emits photons between the 4F_{9/2} energy level and the 6H_{13/2} energy level.

29. The method according to claim 23, wherein said gain medium emits photons between the 4F_{9/2} energy level and the 6H_{11/2} energy level.

30. The method according to claim 23, wherein said pump light has a wavelength of between 300 and 450 nanometers.

31. The method according to claim 23, wherein said pump light has a wavelength of 447 nm.

32. The method according to claim 23, wherein the host material is Yttrium aluminum garnet or Yttrium lithium fluoride.

33. The method according to claim 23, wherein the dysprosium dopant concentration is at least one percent and the host material comprises Yttrium aluminum garnet.

34. The method according to claim 23, wherein the dysprosium dopant concentration is between one percent and two percent, and the host material comprises Yttrium aluminum garnet.

35. The method according to claim 23, wherein the dysprosium dopant concentration is between one percent and five percent, and the host material comprises Yttrium lithium fluoride.

36. The method according to claim 23, further comprising:
focusing the pump light source into the gain medium.

37. The method according to claim 23, wherein a pump light source is at least one laser diode.

38. The method according to claim 37, wherein the at least one laser diode is a gallium nitride laser diode.

39. The method according to claim 23, further comprising:
Q-switching the laser light within the resonant cavity to produce short laser pulses.

40. A method for communications comprising:
generating a series of laser pulses according to claim 23,
encoding a communication signal on the laser pulses; and
transmitting the encoded laser pulses from a source to a receiver.

41. The method according to claim 39, wherein at least one of the source and the receiver is underwater.

42. A method for determining a range to a object, comprising:
generating laser pulses according to claim 23,
transmitting the pulses toward the object;
receiving reflected pulses from the object; and
determining the range based on the time interval between transmitting the pulses and receiving the reflected pulses.

43. The method according to claim 39, wherein the object is underwater.
